(19) United States
(12) Patent Application Publication
(10) Pub. No.: US 2024/0051058 A1
(43) Pub. Date: Feb. 15, 2024

(54) MODULAR TRAILING NOZZLE SYSTEM FOR A WELDING TORCH

(71) Applicant: Linde GmbH, Pullach (DE)

(72) Inventors: Erwan SIEWERT, Pullach (DE); Michael PFREUNTNER, Pullach (DE)

(21) Appl. No.: 18/257,057

(22) PCT Filed: Sep. 16, 2021
(86) PCT No.: PCT/EP2021/025350

§ 371 Date: Jun. 12, 2023

(30) Foreign Application Priority Data
Dec. 16, 2020 (EP) 20020622.5

(51) Int. Cl. B23K 9/32

(52) U.S. Cl. CPC B23K 9/325

(57) ABSTRACT

The present invention relates to a trailing gas nozzle (1) for a welding torch, comprising an elongated body (10) comprising an internal space (11) for receiving a trailing gas (G), and an elongated discharge area (12) on a bottom side of the body (10) for discharging the trailing gas (G) onto a weld seam (S). The body (10) comprises a plurality of segments (101, 102, 103) connected to one another contact surfaces so that a curvature of the discharge area (12) is adjustable to a desired curvature.

The present invention relates to a gas nozzle for a welding torch that allows to cover an elongated, often curved section of a weld seam that has just being welded with a welding torch gas.

Such gas nozzles are also denoted as trailing nozzles, since they follow the arc or weld pool in the welding direction. Particularly, U.S. Pat. No. 5,393,949A and WO2018073293A2 disclose trailing nozzles having a curved discharge area for discharging a gas to protect a weld seam. However, when welding tubes in a peripheral direction for instance, only a fixed diameter range can be covered with such a nozzle. This means that many different trailing gas nozzles are required for different tube diameters.

The problem to be solved by the present invention therefore is to provide a gas nozzle for discharging a trailing gas onto a weld seam that is improved regarding the above-stated disadvantage.

This problem is solved by a gas nozzle having the features of claim 1. Preferred embodiments are stated in the corresponding sub claims and are described below.

According to claim 1, a gas nozzle for a welding torch is disclosed, comprising:
an elongated body comprising an internal space for receiving a trailing gas, and an elongated discharge area on a bottom side of the body for discharging the trailing gas onto a weld seam.

According to the present invention, for adjusting a curvature of the elongated discharge area to a desired curvature corresponding to a curvature of a weld seam to be welded, the elongated body comprises a plurality of segments connected to one another (e.g. rigidly). Preferably, each two neighbouring segments can contact each other via a contact surface of the respective segment, wherein an angle of each contact surface with respect to a center axis of the corresponding segment is selected such that the discharge area comprises said desired curvature. Particularly, the angles do not have to be selected in a unique fashion. In certain embodiments, segments (so called middle segments) are provided that preferably comprise parallel contact surfaces extending at an angle of 90° with respect to a center axis of the respective middle segment, respectively, as well as wedge segments comprising contact surfaces extending at an angle with respect to the center axis of the respective wedge segment, which angles differ from 90°.

Thus, the discharge area can conform to the course of a section of a weld seam that has just been welded with the welding torch to which the gas nozzle is attached and can therefore be covered by the trailing gas in a uniform and efficient manner. Besides the trailing gas, the welding torch itself can discharge a gas for protecting the weld pool and weld seam, which gas is denoted as shielding gas to distinguish the latter from the trailing gas. However, shielding and trailing gas can have the same composition although it is also possible that the compositions differ.

Particularly, in an embodiment at least one segment of said plurality of segments is a wedge segment comprising two opposing contact surfaces being arranged at an angle with respect to one another (i.e. running towards one another). Particularly, each contact surface is arranged at an angle with respect to the center axis of the wedge segment, wherein according to an embodiment, the respective angle lies with the range from 90° to 132° degree. Particularly, in an embodiment, the body comprises several such wedge elements. However, a wedge segment can also comprise opposing contact surfaces that each form an angle of 90° with the center axis (and can be parallel to one another, e.g. so as to achieve a straight body, e.g. in conjunction with said middle segments). In case the wedge segment comprises contact surfaces running towards one another, i.e., having angles differing from 90°, the wedge segment forms an actual wedge, particularly a truncated wedge.

Particularly, according to yet another embodiment, each segment following the first segment can comprise the shape of a wedge, particularly of a truncated wedge, such that a curved discharge area of the body of the gas nozzle results when the segments are mounted to one another. Here, by providing a plurality of segments to choose from, the discharge area of the body can be given the desired curvature by selecting corresponding segments having contact surfaces with appropriate angles with respect to the center axis of the respective segment.

The invention allows one to protect straight as well as curved weld seams during the welding process with only one gas nozzle that is—due to its segments—adaptable to the desired welding task. Due to the fact that the discharge area can be curved in a variable manner, the discharge area can assume a form that ensures that the discharge area essentially comprises a constant distance (normal to the discharge area) within a certain range with respect to the curved weld seam. Particularly, due to the fact that individual segment can have a flat bottom side/outflow area, said distance is not necessarily precisely constant.

Thus, the weld seam can be covered with the trailing gas in a uniform manner.

According to an embodiment of the present invention, a segment of said plurality of segments comprises a gas inlet for feeding trailing gas into the internal space of the body that can then be discharged via said curvature-adjustable discharge area of the gas nozzle.

Furthermore, in an embodiment, the gas nozzle comprises a single gas inlet preferably arranged on one of the segments. The other segments can be configured to distribute the trailing gas along the length of the body of the gas nozzle.

According to an embodiment of the present invention, the body of the gas nozzle comprises a first segment configured to be arranged adjacent the welding torch and configured to be connected to the welding torch. The gas nozzle may be connected to the welding torch using a fastener such as a quick release clamp and similar fasteners that are preferably releasable without the need of using a tool. Other suitable fastening means are also conceivable.

Preferably, said gas inlet is arranged on the first segment. Furthermore, according to an embodiment, the first segment of the gas nozzle can comprise an opening for receiving the torch, particularly in a form-fitting manner, for mounting the torch to the first segment of the gas nozzle.

Particularly, in an embodiment, the fastener is a clamp that surrounds the welding torch and is mounted to the first segment of the trail that can be connected to further segments. Particularly, in an embodiment, the fastener is a clamp that surrounds an opening of the first segment, the opening being configured for receiving an end portion of the welding torch. Particularly, the clamp comprises a lever, the lever being pivotable between an open position and a closed position, wherein in the open position said opening comprises an inner diameter being larger than an outer diameter of said end portion of the welding torch allowing insertion of said end portion of the welding torch into the opening of the first segment, and wherein in the second position of the lever, the inner diameter of said opening is reduced to clamp said end portion of the welding torch and to therewith fasten the first segment to the welding torch.

Particularly, the welding torch can be integrated into the gas nozzle, particularly into the first segment, wherein preferably the welding torch does not comprise a separate shielding gas nozzle, but particularly uses the gas nozzle for providing the entire trailing/shielding gas needed to cover the weld seam.

According to a further embodiment, the plurality of segments comprises a last segment (also denoted as end segment). The last segment being arranged at an opposite end of the body with respect to the first segment.

According to an embodiment, at least one segment of said plurality of segments is a middle segment, wherein the middle segment preferably comprises two opposing contact surfaces for contacting contact surfaces of neighbouring segments, wherein the contact surfaces of the middle segment extend parallel to one another and are each perpendicular to a center axis of the middle segment. Particularly, in an embodiment, the middle segment is configured to be arranged between two wedge elements.

Further, according to an embodiment of the present invention, at least one segment of said plurality of segments comprises a conduit configured to receiving a cooling fluid for cooling the at least one segment. Particularly, said at least one segment to be cooled is the first segment of the gas nozzle that is configured to be arranged adjacent the welding torch and connected to the welding torch. The first segment in the vicinity of the welding torch is arranged closest to the arc and the heat generated by the latter so that cooling of at least the first segment of the body of the gas nozzle can be useful for protecting the gas nozzle from excessive heat.

Furthermore, each segment can comprise a conduit for receiving a cooling fluid. The conduits can be in fluid connection so that the cooling fluid can be passed from one segment to a neighbouring segment of the body of the gas nozzle.

According to yet another embodiment of the present invention, the first segment of the body of the gas nozzle consists out of or comprises a heat resistant material (e.g. a metal or a ceramics). Alternatively, or in addition, the first segment can comprise a heat absorber for absorbing heat generated by the arc of the welding torch. Preferably, the heat absorber is positioned to absorb most of the arc energy, wherein it is particularly located at a position where hot plasma reflected from the workpiece hits the gas nozzle.

Furthermore, according to an embodiment of the present invention, the body or at least one segment of said plurality of segments comprises a gas distributor.

Particularly, several of said plurality of segments can comprise a gas distributor, particularly a first segment, a middle segment, and a last segment of said plurality of segments. Furthermore, each segment of said plurality of segments can comprise a gas distributor.

Furthermore, according to an embodiment, the first segment comprises a gas distributor. Further, in an embodiment, the middle segment comprises a gas distributor. Further, in an embodiment, the last (end) segment comprises a gas distributor. Further in an embodiment, the wedge segment does not comprise a gas distributor.

Particularly, according to an embodiment, apart from the first and the last segment, the plurality of segments comprises several wedge segments and several middle segments, wherein the first, the last and each middle segment comprises a gas distributor, respectively, wherein particularly the wedge segment do not comprise gas distributors.

Further, each segment can comprise a channel, particularly a channel integrated into a wall of the respective segment to establish a flow connection between the gas distributors. Particularly, in an embodiment, the gas nozzle can comprise e.g. up to five middle segments (i.e. segments between the first and the last segment). Each middle segment can comprise a gas distributor.

According to an embodiment, the respective gas distributor comprises or is formed out of a porous material. Particularly, the porous material can be a sintered material. Particularly, sinter bronze or brass can be used.

Furthermore, according to an embodiment, each segment is releasably connected to its neighbouring segment(s), particularly by means of a screwed connection or a snap-in connection. Particularly each segment is connected to a neighbouring segment by a threaded bolt. Furthermore, particularly, the first segment at a proximal end of the body and an end segment of the body at a distal end of the body of the gas nozzle only comprise a single neighbouring segment.

Furthermore, according to an embodiment of the present invention, each segment comprises a top wall and two opposing lateral walls and an outflow area arranged between the lateral walls and facing the top wall, so that the trailing gas can be discharged through the outflow area, wherein the outflow areas together form said discharge area of the body of the gas nozzle.

Furthermore, in an embodiment, several segments of said plurality of segments comprises a protrusion on one of the contact surfaces and a corresponding recess on the other opposing contact surface, wherein the channel of the respective segment extends from the protrusion to the recess, i.e., the channel opens on the protrusion and into the recess.

Particularly, in an embodiment, the protrusion of the respective segment is configured to be arranged in a form-fitting manner in a corresponding recess of a contact surface of a neighbouring segment when the segment is connected to the neighbouring segment for aligning the segments with respect to one another, and particularly for providing a flow connection between the two channels, as will be described further below in more detail.

Particularly, in an embodiment, the respective wedge segment and/or the respective middle segment each comprise such a protrusion and recess.

Furthermore, in an embodiment, the last (i.e. end) segment comprises a protrusion protruding from a contact surface from the last segment, the protrusion being configured to be received by a corresponding recess of the contact surface of a neighbouring segment. The channel of the last segment that particularly connects to the gas distributor of the last segment opens on the protrusion.

Furthermore, in an embodiment, the first segment comprises a recess on the contact surface of the first segment, the recess being configured to receive a protrusion of the contact surface of a neighbouring segment.

Furthermore, in an embodiment, a seal (particularly an O-ring seal) is arranged on the respective protrusion to seal said flow connection between two neighbouring channels at the interface between the respective protrusion and the corresponding recess.

Furthermore, in an embodiment, each two neighbouring segments are connected to one another via a threaded bolt that extends through one of the neighbouring segments and is screwed into an inner thread of a hole (particularly blind hole) of the other neighbouring segment so that the contact surfaces of the two neighbouring segments that face one another contact one another and a sealed flow connection between the channels of the two neighbouring segments is established by pressing the protrusion of one of the neighbouring segments into the recess of the other neighbouring segment. Particularly, the seal (e.g. O-ring) seals the flow connection between the two channels. Furthermore, in an embodiment, the threaded bolts and corresponding holes are arranged in an alternating fashion on the right side of the channels and on the left side of the channels, particularly so as to realize a poka yoke assembly scheme.

Preferably, according to an embodiment, each outflow area is covered by a flexible sheet comprising a plurality of discharge openings, the respective sheet being particularly configured for braking and homogenizing a gas flow of the trailing gas discharged through the respective outflow area/discharge openings. Particularly, the respective sheet can be a metallic screen or a perforated plate. Particularly, the respective sheet is thin and flexible so that it easily adapts to the angular positions of the segments and allows the discharge area to assume a desired curvature to conform to the workpiece/curvature of the weld seam. Alternatively, the outflow areas, i.e. the discharge area, can be covered by a single flexible sheet of the afore-mentioned kind. Preferably, in an embodiment, the single flexible sheet is a metallic mesh. Particularly in case of Wolfram inert gas welding (WIG) a metallic mesh is used. In case of higher temperatures (e.g., as in plasma arc welding (PAW)) a perforated plate may be used alternatively or in addition to the metallic mesh for protections against heat generated by the arc, at least in the vicinity of the first segment.

Particularly, in an embodiment, the flexible sheet comprises a hole to allow an electrode of the welding torch to protrude out of the gas nozzle through said hole when the gas nozzle is connected to the welding torch.

Furthermore, in an embodiment, the body comprises a groove on an inside for receiving the flexible sheet.

As described above, the first segment is preferably configured to be connected to a welding torch in a releasable fashion. According to a preferred embodiment, the first segment of the body comprises an opening for receiving the welding torch so that the latter can be mounted to the gas nozzle in a safe and reproducible manner. The remaining segments can be considered as extension segments that allow to prolong the body of the nozzle as needed and to lend the discharge areas a desired course/curvature that is adapted to the workpiece and welding seam to be covered with trailing gas. Particularly, the first segment is also denoted as main segment and is individually adapted to the welding torch geometry or comprises components that allow an adaptation to the welding torch (e.g. such as sealing lips or adapters).

However, the segments can comprise or can be formed out of different materials. Particularly, segments made of metal can be used for welding processes with high temperatures. Particularly, only those segments arranged at a distance to the first segment are made out of a plastic material according to an embodiment. The number of metallic segments used particularly depends on the maximum permissible temperature of the plastic material as well as on the surrounding gas temperature and the radiant energy of the welding process. In an embodiment, the first segment is formed out of a metal or comprises a metal, particularly for heat protection, wherein the end segment is preferably formed out of a plastic material. According to a further embodiment, an intermediary segment arranged between the first segment and the end segment is formed out of a plastic material, too.

According to a further embodiment, the first segment is at least partially transparent for allowing visual inspection of the weld pool upon welding. Particularly, the first segment can be made out of a transparent material (e.g. a glass) or may partially contain such a material (e.g. a glass), so that the visibility of the weld pool is ensured.

For processes with strong evaporation or spattering, the gas nozzle can comprise a protective plate (perforated plate) that is placed on the first segment in front of the gas distributor.

Furthermore, the gas nozzle can comprise cooling segments that are used for cooling workpieces that heat up particularly strongly during welding. These cooling segments reduce the workpiece temperature below a critical value. The individual cooling segments can also be adjusted in any spatial direction (e.g. by means of a joint such as a ball joint).

According to an embodiment of the gas nozzle, the gas nozzle is configured to discharge a trailing gas through the discharge area having a gas flow rate in the range between 2 l/min and 20 l/min per segment. The trailing gas can be one of or can comprise a mixture of: Argon, helium, nitrogen, hydrogen.

According to a further aspect, a kit for providing a gas nozzle for a welding torch is disclosed, wherein the kit is particularly configured for providing a gas nozzle according to the present invention, and wherein the kit comprises:
a plurality of segments comprising a first segment, a last segment, a plurality of middle segments, and a plurality of wedge segments, the segments being configured to be connected to one another to form an elongated body of the gas nozzle, so that the body comprises an internal space for receiving a trailing gas, and an elongated discharge area on a bottom side of the body for discharging the trailing gas onto a weld seam, each middle segment being configured to be arranged between two wedge segments, each wedge segment comprising at least one contact surface (particularly two opposing contact surfaces) that is (are) configured to contact a contact surface of a neighbouring segment, wherein the at least one contact surface is arranged at an angle with respect to a center axis of the respective wedge segment (particularly, in case the respective wedge segment comprises two opposing contact surfaces, these contact surfaces preferably run towards one another so that the wedge segment comprises a wedge shape),
wherein for adjusting a curvature of the elongated discharge area to a desired curvature of the weld seam, the kit comprises wedge segments having different angles of the at least one contact surface (or of the opposing contact surfaces) so that bodies with different curvatures can be realized.

In other words, the wedge segments are available in different angle increments. Thus, selecting the proper segments from the plurality of segments provided by the kit allows one to assemble a gas nozzle having a body with discharge area of desired curvature.

The kit according to the present invention can be further specified by the features and embodiments disclosed in conjunction with the gas nozzle according to the present invention.

Yet another aspect of the present invention relates to a method for welding, wherein a gas nozzle according to the present invention is connected to the welding torch, wherein a curvature of the discharge area of the gas nozzle is adjusted to a desired curvature adapted corresponding to a curvature of a weld seam that is to be welded, by releasably connecting segments to one another, wherein each two neighbouring segments contact each other via a contact surface of the respective segment, an angle of each contact surface with respect to a center axis of the corresponding segment being selected such that the discharge area comprises the desired curvature.

Particularly, after having configured the gas nozzle to have the desired curvature, the weld seam is welded and the gas nozzle is used to discharge a trailing gas onto the weld seam.

Further, according to an embodiment of the method, a trailing gas is discharged through the discharge area of the body of the nozzle having a gas flow rate in the range between 2 l/min and 20 l/min per segment. The trailing gas can be one of or comprise a mixture of: Argon, helium, nitrogen, hydrogen.

In the following, embodiments of the present invention as well as further features and advantages of the present invention are described with reference to the Figures, wherein

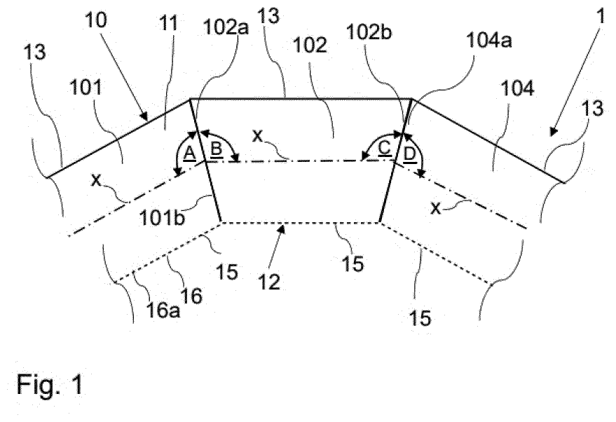

FIG. 1 shows a schematic lateral view of an embodiment of a gas nozzle according to the present invention,

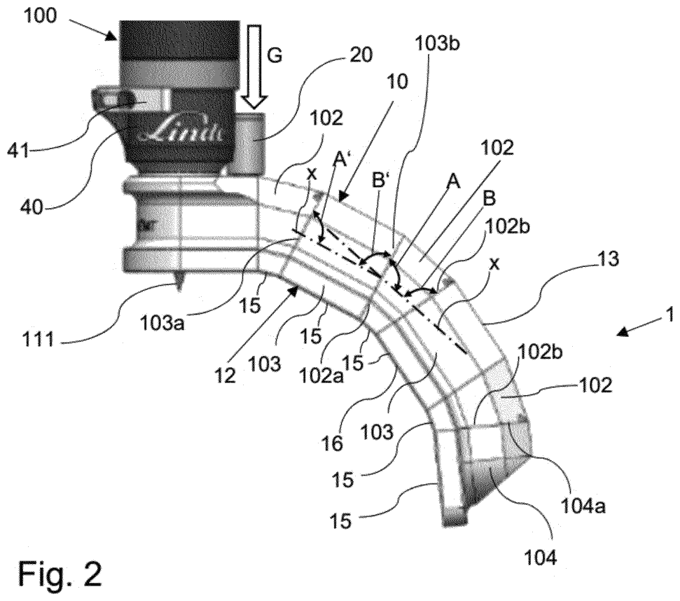

FIG. 2 shows a lateral view onto a preferred embodiment of the gas nozzle according to the present invention,

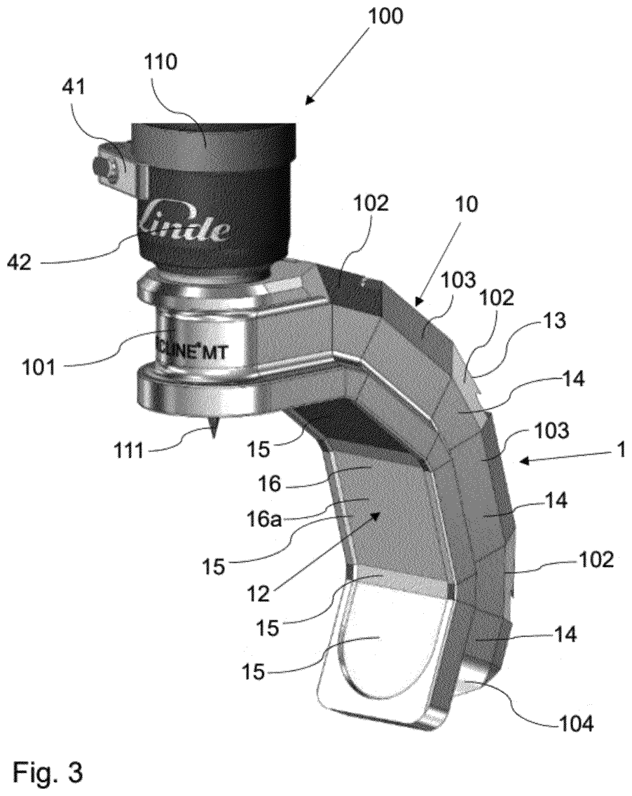

FIG. 3 shows a perspective view of the gas nozzle shown in FIGS. 2,

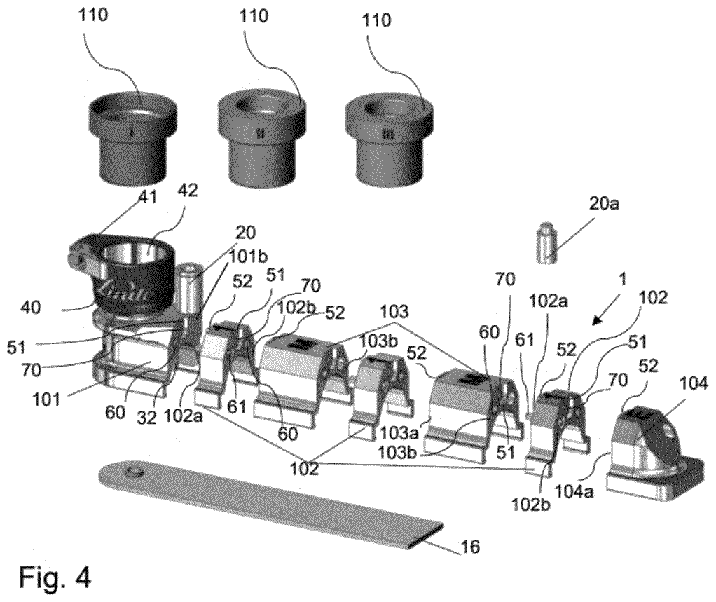

FIG. 4 shows a view of an embodiment of the gas nozzle according to the present invention illustrating the modular character of the gas nozzle, which comprises a first segment and a last (end) segment and a mesh, wherein the first and the last segment as well as the middle segments are delivered with pre-assembled gas distributors and the first segment with a pre-assembled clamp and gas inlet, wherein depending on the specific application further middle segments and wedge segments can be applied, and

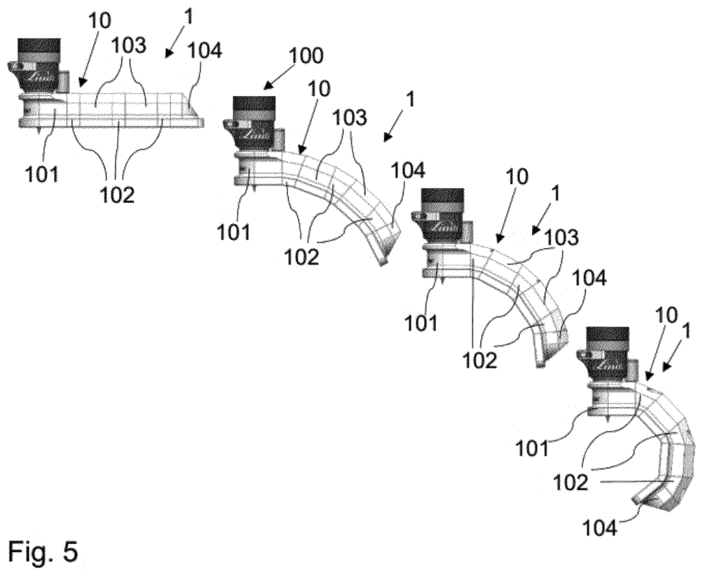

FIG. 5 shows a lateral view of different combinations of segments of an embodiment of the gas nozzle according to the present invention,

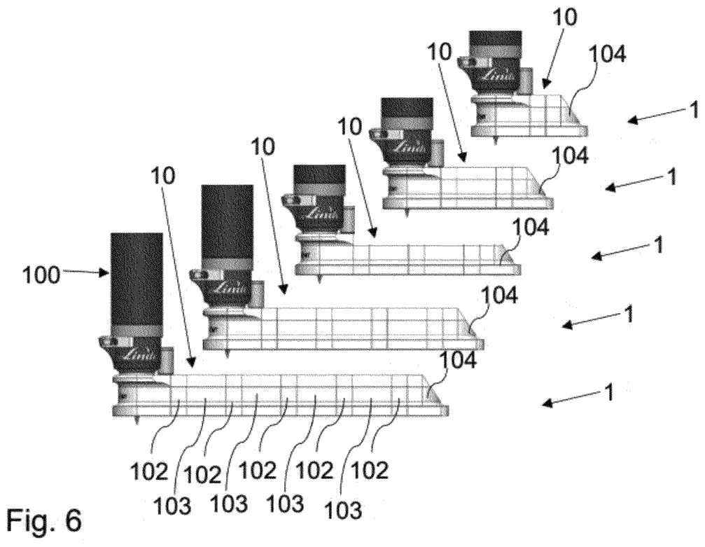

FIG. 6 shows a further lateral view of different combinations of segments of an embodiment of the gas nozzle according to the present invention, and

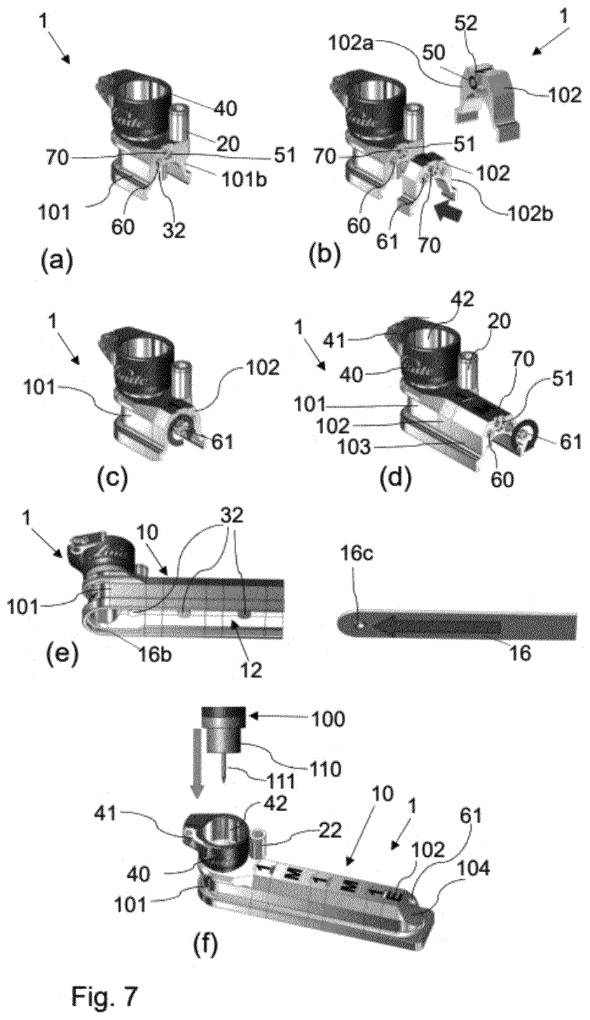

FIG. 7 shows a sequence of combining the segments of the gas nozzle to achieve a gas nozzle having a desired curvature adapted to a specific welding task.

FIG. 2 shows a lateral view of an embodiment of a gas nozzle 1 for a welding torch 100 according to the present invention. The gas nozzle 1 comprises an elongated body 10 comprising an internal space 11 for receiving a trailing gas G, and an elongated discharge area 12 on a bottom side of the body 10 for discharging the trailing gas G onto a weld seam. The body 10 comprises a plurality of segments 101, 102, 103, 104 connected to one another in a movable fashion so that a shape, particularly curvature of the discharge area 12 is adjustable.

Particularly, FIGS. 2 and 3 indicate that the discharge area 12 that is formed by the combined outflow areas 15 of the segments 101, 102, 103, 104 of the body 10 of the gas nozzle 1 can be adapted to the shape of a welding seam S to be welded. This particularly applies to all embodiments of the present invention. Further, this feature is particularly useful when welding tubes of different diameter so that the same nozzle 1 can be used by merely adjusting the curvature of the discharge area 12 when using the nozzle 1 on tubes that comprise a different diameter than the ones welded before. Of course, also parts other than tubes can be welded using the gas nozzle 1 according to the present invention. As can be seen from FIGS. 5 and 6, the possibility to adapt the curvature/shape of the discharge area 12 of the nozzle 1 allows to configure the nozzle 1 in a way that the discharge area 12 can be adapted to different curvatures of a weld seam that is to be protected with the trailing gas G and also to different lengths of a weld seam section that is to be protected (FIG. 5).

Thus, the respective discharge area 12 comprises essentially a constant distance to the weld seam over the length of the body 10 of the nozzle 1 along the weld seam. This allows to efficiently cover the weld seam with the trailing gas G which greatly improves protection of the weld seam upon welding.

Due to the fact that the body 10 consists out of segments 101, 102, 103, 103 the gas nozzle 1 is a modular gas nozzle 1 that can be lengthened/shortened and oriented in space with respect to the curved weld seam as the shape of the weld seam/workpiece to be welded demands (cf. FIGS. 5 and 6)

Particularly, the segments 101, 102, 103, 104 are quickly adaptable to the desired component/weld seam geometry which allows considerable savings in set-up time. Furthermore, only simple tools such as an Allen key are required for combining the individual segments 101, 102, 103, 104. the adjustment.

Moreover, the design according to the present invention is flexible and works with all kind of welding torches. Particularly, the gas nozzle 1 according to the present invention can be used with standard TIG, Plasma and MSG welding torches.

As indicated in FIG. 2, the gas nozzle 1 comprises a gas inlet 20 positioned particularly on a first segment 101 of the body 10 of the nozzle 1 for feeding the trailing gas G into the internal space 11 of the body 10. Optionally, selected segments 101, 102, 103, 104 can comprise a conduit 30 configured to receive a cooling fluid for cooling the respective segment.

As indicated in FIGS. 2, 3, and 4 the first segment 101 of the body 10 of the nozzle 1 is configured to be arranged adjacent a welding torch 100 and connected to the latter by means of a releasable fasting means. Preferably, this fastening means is a clamp 40, the clamp 40 surrounding an opening 42 of the first segment 101 and comprising a lever 41, wherein the lever 41 is pivotable between an open position and a closed position, wherein in the open position said opening 42 comprises an inner diameter being larger than an outer diameter of an end portion of the welding torch 100 allowing insertion of said end portion of the welding torch 100 into the opening 42 of the first segment 101, and wherein in the second position of the lever 41, the inner diameter of said opening 42 is reduced to clamp said end portion of the welding torch 100 and to therewith fix the first segment 101 to the welding torch 100. Particularly, the nozzle can comprise different adapter sleeves 110 that can be arranged on the end portion of the torch 100 so that torches of different outer diameter can be used with the nozzle 1. However, other suitable fastening means may also be used. Particularly, due to the fact that the first segment 101 is positioned close to the arc A generated with the torch 100 during welding it preferably consists out of a heat resistant material and/or may comprise a heat absorber for absorbing heat generated by the arc.

As particularly indicated in FIG. 7(e) the first segment 101, each so-called wedge segment 102 to be described in more detail below, and each middle segment 103 (each middle segment 103 being arranged between two wedge segments 102) and a last (end) segment 104 that will also be described in more detail below, preferably comprise a gas distributor 32.

Furthermore, as e.g. indicated in FIGS. 2 and 3, each segment 101, 102, 103, 104 that forms the elongated adjustable body 10 of the nozzle 1 preferably comprises a top wall 13 and two opposing lateral walls 14 and an outflow area 15 arranged between the lateral walls 14 and facing the top wall 13 (cf. e.g. FIGS. 2 to 3), so that the trailing gas G can be discharged through the outflow area 15 or the respective segment onto the welded weld seam 4 (cf. FIG. 4) wherein the outflow areas 15 together form said discharge area 12 of the body 10 of the gas nozzle 1. Particularly, a single flexible sheet 16 (cf. also FIG. 7(e)), e.g. a metallic mesh or a perforated plate, can cover all outflow areas 15/the discharge area 12. The sheet 16 can comprise a hole 16c for an electrode 111 of the torch 100. Alternatively, each outflow area 15 may also be covered by a flexible sheet comprising a plurality of discharge openings 16a for discharging the trailing gas G, so that the discharge area 12 is covered by multiple sheets. Particularly, the kit according to the present invention can comprise a cutting device configured to cut the sheet 16 so as to allow a user to adapt a length of the sheet to a selected length of body 10.

In order to be able to efficiently adapt the shape of the discharge area 12 of the body of the gas nozzle 1 to the weld seam S, the nozzle 1 comprises a plurality of segments 101, 102, 103, 104 that can be combined in a modular fashion so as to achieve different lengths and/or curvatures of the discharge area 12/body 10 as indicated in FIGS. 5 and 6.

Preferably, as shown in FIG. 4, the nozzle 1 comprises a first segment 101 comprising the clamp 40 and the gas inlet 20 (the gas inlet 20 can be adapted to different hose diameters using replacement parts such as gas plug 20a), wedge segments 102, middle segments 103 and a last (or end) segment 104.

Particularly, while the middle segments 103 preferably comprise parallel contact surfaces 103a, 103b for contacting neighbouring segments, the wedge segments 102 can comprise contact surfaces 102a, 102b that are arranged at an angle to one another. However, the wedge segments 102 may also comprise parallel contact surfaces 102a, 102b as shown in FIG. 4, so as to be able to combine the segments to a straight body 10. By selecting middle segments 103 with parallel contact surfaces 103a, 103b and wedge segments 102 with contact surfaces 102a, 102b that extend at a desired angle A, B with respect to a center axis x of the respective wedge segment 102 as shown in FIG. 2, the different curvatures of the body 10 shown in FIG. 5 can be realized. The more angled the contact surfaces 102a, 102b (angles A, B) are, the smaller the resulting radius of the body 10/discharge area 12. Thus, particularly, like the contact surfaces of the first and last segment 101, 104, the angles A′, B′ of the contact surfaces 103a, 103b of the middle segments 103 are selected to be 90° with respect to the center axis x of the respective middle segment 103, while the angles A, B of the contact surfaces 102a, 102b of the wedge segments 102 can be selected so as to particularly differ from 90° to give the respective wedge segment 102 an actual wedge shape, thus allowing to achieve a curved body 10 of the nozzle 1 as desired. In order to be able to achieve different curvatures, the kit according to the present invention preferably comprises wedge segments 102 of different angles A, B.

Alternatively, as shown in FIG. 1, it is also possible to also provide contact surfaces that extend at an angle other than 90° on segments that connect to a wedge segment 102. Particularly, according to FIG. 1, each two neighbouring segments 101, 102; 102, 104 of the body 10 of the gas nozzle 1 contact each other via a contact surface 101b, 102a; 102b, 104a of the respective segment 101, 102, 104, wherein an angle A, B, C, D of each contact surface 101b, 102a, 102b, 104a with respect to a center axis x of the corresponding segment 101, 102, 104 is selected such that the discharge area 12 comprises said desired curvature. Also, here, the gas nozzle 1 can be a modular system as described above, comprising a plurality of different segments 101, 102, 104 out of which a particular number of segments are chosen that comprise contact surfaces with angles that result in the desired curvature of the discharge area 12 once the segments are mounted to one another such that the contact surfaces 101b, 102a; 102b, 104a contact one another as shown in FIG. 1. Particularly, the angles A and D of the first segment and the last segment can also be 90°. FIG. 5 merely shows one segment 102 between the first and the last segment 101, 104, but the gas nozzle 1 can comprise several such segments 102. In an embodiment, the angles A and D can be 90° while the angles of the segment(s) 120 can differ from 90° and can assume e.g. up to 90°±42°. Other values are also conceivable.

Particularly, the segments 101, 102, 103, 104 of the various embodiments of the present invention can be mounted to one another by means of screws 61.

Particularly, in all embodiments, the gas distributors 32 can be connected to one another by channels 70 integrated into the respective segment 101, 102, 103, 104 as indicated e.g. in FIG. 4.

Furthermore, as shown in FIG. 4, the individual segments 102, 103, 104 each comprises a protrusion 52 on one of their contact surfaces 102a, 103a, 104a. The respective protrusion 52 is configured to be arranged in a form-fitting manner in an associated recess 51 of an opposing contact surface 101b, 102b, 103b of a neighbouring segment 101, 102, 103. Since the channels 70 which distribute the trailing gas G from the gas inlet 20 to the gas distributors 32, extend between the protrusion 52 and recess 51 of the respective segment 102, 103, a flow connection can be provided by connecting the segments 101, 102, 103, 104 to one another via their contact surfaces. Particularly, a seal 50 (cf. FIG. 7(b)) is arranged on each protrusion to seal the flow connections. Likewise, the first segment 101 comprises a recess 51 for receiving a protrusion 52 of the neighbouring wedge segment 102 to connect the channel of the latter to the gas inlet 20. Further, the last segment 104 comprises a protrusion 52 that is arranged in the recess 51 of the penultimate segment 102 so as to connect the gas distributor of the last segment 104 to the channel 70 of the neighbouring segment 102.

Further, as indicated in FIG. 4, each two neighbouring segments 101, 102, 103, 104 are connected to one another via a threaded bolt 61 that extends through one of the neighbouring segments and is screwed into an inner thread of a hole 60 of the other neighbouring segment, particularly the threaded bolts 61 and corresponding holes 60 are arranged in an alternating fashion on the right side of the channels 70 and on the left side of the channels 70. This allows one to achieve a rigid connection between the segments 101, 102, 103, 104 but also established a poka yoke principle so that individual segments cannot be arranged with respect to one another in the wrong order.

Particularly, FIG. 7 illustrates the mounting procedure according to which a gas nozzle 1 is combined from individual segments 101, 102, 103, 104, namely from a first segment and a last segment as well as a selected number of wedge segments 102 and middle segments 103, wherein the middle segments 103 are particularly termed middle segments 103 since they can each be arranged between two wedge segments 102. Particularly, the middle segments 103 comprise parallel contact surfaces 103a, 103b while the wedge segments 102 comprise contact surfaces 102a, 102b that extend at an angle A, B with respect to the center axis x. These angles can each be in the range between 90° and 90°±42°. Particularly, the angles A, B can be equal. However, in order to achieve straight nozzle bodies 10 as shown in FIG. 6, also the wedge segments 102 can have parallel contact surfaces 102a, 102b that extend perpendicular with respect to the respective center axis x of the segment 102.

Particularly, the mounting procedure starts with the first segment 101. This segment 101 comprises the clamp 40 and the gas inlet 20 (cf. FIG. 7(a)).

Then, according to FIG. 7(b), the first wedge segment 102 is attached to the first segment 101 by putting the protrusion 52 of the wedge segment 102 into the recess 51 of the first segment. A seal 50, particularly in form of an O-ring, seals the flow connection between the channels 70 of the two segments 101, 102.

Further, according to FIG. 7(c) both segments 101, 102 are connected by threaded bolt 61 screwed through segment 102 into hole 60 of the first segment 101. Next, according to FIG. 7(d), a middle segment 103 is connected by a further threaded bolt 61 to the wedge segment 102, wherein the protrusion 52 of middle segment 103 is arranged in a recess 51 of the wedge segment 102 and sealed with a further seal 50 (not shown). This procedure is repeated until the body 10 of the nozzle 1 comprises the desired length. Then, according to FIG. 7(f) sheet 16 is inserted into the groove 16b of the body 10 and cut to length. After having covered the discharge area 12 of the nozzle 1 with flexible sheet 16, the last segment 104 as shown in FIG. 7(f) is connected to the penultimate wedge segment 102 by means of yet another threaded bold 61. Particularly, all the bolts 61 are arranged in an alternating fashion on the left-hand side and on the right-hand side of the channels 70 along the body 10 of the nozzle 1.

1. A gas nozzle for a welding torch, comprising:
an elongated body comprising an internal space for receiving a trailing gas (G), and an elongated discharge area on a bottom side of the body for discharging the trailing gas (G) onto a weld seam (S),
wherein
for adjusting a curvature of the elongated discharge area to a desired curvature, the elongated body comprises a plurality of segments rigidly connected to one another, wherein each two neighbouring segments contact each other via a contact surface of the respective segment, wherein an angle (A, B, C, D) of each contact surface with respect to a center axis (x) of the corresponding segment is selected such that the discharge area comprises said desired curvature.

2. The gas nozzle according to claim 1, wherein a segment of said plurality of segments comprises a gas inlet for feeding the trailing gas into the internal space of the body.

3. The gas nozzle according to claim 1, wherein the gas nozzle comprises a first segment configured to be arranged adjacent the welding torch and to be connected to the welding torch.

4. The gas nozzle according to claim 3, wherein the first segment comprises a clamp for connecting the gas nozzle to the welding torch, the clamp surrounding an opening of the first segment and comprises a lever, the lever being pivotable between an open position and a closed position, wherein in the open position said opening comprises an inner diameter being larger than an outer diameter of an end portion of the welding torch allowing insertion of said end portion of the welding torch into the opening of the first segment, and wherein in the second position of the lever, the inner diameter of said opening is reduced to clamp said end portion of the welding torch and to therewith fasten the first segment to the welding torch.

5. The gas nozzle according to claim 1, wherein the plurality of segments comprises a last segment being arranged at an opposite end of the body with respect to the first segment.

6. The gas nozzle according to claim 1, wherein at least one segment of said plurality of segments is a wedge segment comprising two opposing contact surfaces being arranged at an angle with respect to one another.

7. The gas nozzle according to claim 1, wherein at least one segment of said plurality of segments is a middle segment, the middle segment comprising two opposing contact surfaces for contacting contact surfaces of neighbouring segments, wherein the contact surfaces of the middle segment extend parallel to one another.

8. The gas nozzle according to claim 1, wherein at least one segment of said plurality of segments comprises a gas distributor; or wherein several of said plurality of segments comprise a gas distributor, particularly a first segment, a middle segment, and a last segment of said plurality of segments; or wherein all segments of said plurality of segments comprise a gas distributor.

9. The gas nozzle according to claim 1, wherein each segment of said plurality of segments comprises a top wall and two opposing lateral walls and an outflow area arranged between the lateral walls and facing the top wall, so that the trailing gas (G) can be discharged through the outflow area in the direction of a workpiece to be welded, wherein the outflow areas together form said discharge area of the body of the gas nozzle.

10. The gas nozzle according to claim 1, wherein several segments of said plurality of segments each comprise a protrusion on one of the contact surfaces of the respective segment and a corresponding recess on the other opposing contact surface of the respective segment, wherein the respective segment comprises a channel extending from the protrusion to the recess of the respective segment, and wherein the protrusion of the respective segment is configured to be arranged in a form-fitting manner in a corresponding recess of the contact surface of a neighbouring segment for providing proper alignment between the respective segment and the neighbouring segment.

11. The gas nozzle according to claim 3, wherein the last segment comprises a protrusion protruding from a contact surface of the last segment, the protrusion being configured to be received by a corresponding recess of the contact surface of a neighbouring segment for providing proper alignment between the last segment and the neighbouring segment; and/or wherein the first segment comprises a recess on the contact surface of the first segment, the recess being configured to receive a protrusion of the contact surface of a neighbouring segment for providing proper alignment between the first segment and the neighbouring segment.

12. The gas nozzle according to claim 1, wherein each two neighbouring segments are connected to one another via a threaded bolt that extends through one of the neighbouring segments and is screwed into an inner thread of a hole of the other neighbouring segment so that the contact surfaces of the two neighbouring segments that face one another contact one another and a sealed flow connection between the channels of the two neighbouring segments is established by pressing the protrusion of one of the neighbouring segments into the recess of the other neighbouring segment, wherein particularly the threaded bolts and corresponding holes are arranged in an alternating fashion on the right side of the channels and on the left side of the channels.

13. The gas nozzle according to claim 9, wherein each outflow area is covered by a flexible sheet comprising a plurality of discharge openings for discharging the trailing gas (G), or wherein the discharge area is covered by a single flexible sheet comprising a plurality of discharge openings for discharging the trailing gas (G).

14. A kit for providing a gas nozzle for a welding torch, particularly according to claim 1, comprising:
a plurality of segments comprising a first segment, a last segment, a plurality of middle segments, and a plurality of wedge segments, the segments being configured to be connected to one another to form an elongated body of the gas nozzle, so that the body comprises an internal space for receiving a trailing gas (G), and an elongated discharge area on a bottom side of the body for discharging the trailing gas (G) onto a weld seam (S), each middle segment being configured to be arranged between two wedge segments, each wedge segment comprising at least one contact surface configured to contact a contact surface of a neighbouring segment, wherein the at least one contact surface is arranged at an angle (A, B) with respect to a center axis (x) of the respective wedge segment, wherein for adjusting a curvature of the discharge area to a curvature of a weld seam, the kit comprises wedge segments having different angles (A, B).

15. A method for welding, wherein a gas nozzle according to claim 1 is connected to a welding torch, wherein a curvature of the discharge area of the gas nozzle is adjusted to a desired curvature corresponding to a curvature of a weld seam (S) that is to be welded, by
releasably connecting segments to one another, wherein each two neighbouring segments contact each other via a contact surface of the respective segment, an angle of each contact surface (A, B, C, D) with respect to a center axis (x) of the corresponding segment being selected such that the discharge area comprises the desired curvature.
